(19) United States
(12) Patent Application Publication
(10) Pub. No.: US 2002/0176014 A1
(43) Pub. Date: Nov. 28, 2002

(54) Camera with a contour improvement circuit and method implemented in such an apparatus

(76) Inventor: Frederic Bompard, Massy (FR)

Correspondence Address: U.S. Philips Corporation, 580 White Plains Road, Tarrytown, NY, 10591, US

(21) Appl. No.: 10/104,910

(22) Filed: Mar. 22, 2002

(30) Foreign Application Priority Data
Mar. 27, 2001 (FR) 0104106

(51) Int. Cl. H04N 9/64

(52) U.S. Cl. 348/253; 348/222.1; 348/252

(57) ABSTRACT

This camera having a contour improvement circuit (13) is formed from a sensor (3) composed of elements sensitive to various color components in the view exhibiting an entire spectrum of spatial frequencies, and at least a first image filtering device (10) for the low frequencies in the spectrum with a view to processing the signals issuing from said sensitive elements. It is in the form of a first branch (B1) in which said first filtering device (10) is inserted, and at least a second branch (B2) in which the contour improvement circuit (13) is inserted in order to act on the high frequencies taking account of all the signals issuing from said elements, and a combination device (16) for supplying an image from the output signals of said branches.

The invention relates to a camera having a contour improvement circuit, an apparatus formed from a sensor composed of elements sensitive to various color components in the view exhibiting an entire spectrum of spatial frequencies, and at least a first image filtering device for the low frequencies in the spectrum with a view to processing the signals issuing from said sensitive elements.

The invention also relates to a method implemented in such an apparatus.

An apparatus of this type is described in U.S. Pat. No. 5, 285,267. The apparatus described relates more to TV applications than to photographic cameras. In this document, a processing based on the chrominance signals in order to obtain an improvement of contour is proposed.

The present invention proposes an apparatus of the type mentioned in the preamble which presents another approach for improvement of contour.

To this end, such an apparatus is characterized in that it has a first branch in which said first filtering device is inserted, at least a second branch in which at least a contour improvement circuit is inserted in order to act on the high frequencies taking account of all the signals issuing from said elements, and a combination device for supplying an image from the output signals of said branches.

A method implemented in such an apparatus is characterized in that it includes the following steps:

impression of the sensor composed of elements sensitive to the various color components of the view,

processing the information from this sensor by a first processing branch operating on the elements sensitive to color,

processing the information from this sensor by a second processing branch operating on all the elements without taking account of the color and operating on the upper part of the spatial spectrum, with a view to improving the contours,

combination of the various items of information produced by said branches in order to supply an image for use.

The idea of the invention therefore consists of effecting this improvement of contour on the upper part of the spectrum of spatial frequencies, which is obtained by taking account of all the pixels of the sensor without consideration of color.

The invention will be further described with reference to examples of embodiments shown in the drawings to which, however, the invention is not restricted:

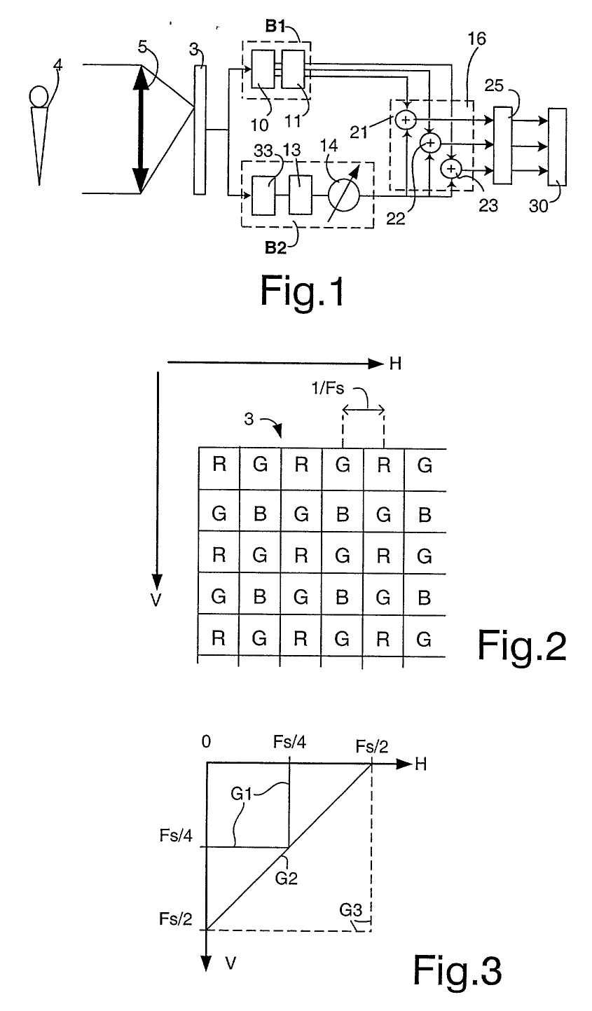

FIG. 1 shows a diagram of the apparatus according to the invention.

FIG. 2 shows in more detail the structure of an apparatus according to the invention.

FIG. 3 shows the outline of the spatial spectrum processed by the apparatus in accordance with the invention.

FIG. 1 shows a camera according to the invention. The reference 3 indicates the sensor having a plurality of elements sensitive to various color components. The sensor is shown in more detail in FIG. 2. The subject 4, which is obtained by means of a lens 5, is focused on this sensor.

The various elements of the sensor, disposed in a matrix in horizontal H and vertical V directions, are sensitive to the three primary colors:

blue, these elements are indicated by the letter “B” in FIG. 2

red, these elements are indicated by the letter “R” in FIG. 2

green, these elements are indicated by the letter “G” in this same FIG. 2.

At the output of this sensor, it is possible to collect various signals corresponding to each of said color components. These various color components undergo a filtering operation performed by a first filtering device 10 (FIG. 1). This operation consists of a filtering in two dimensions 2D normal for this type of apparatus and its purpose is to prevent the colored moire effects, among other things, due to spectral overlaps. A color reconstruction filtering 11 is connected to the output of this device 10, and regularizes the perception of the colors.

According to the invention this filtering device 10 and the filter 11 are put in a first branch B1, while the improvement circuit 13 intended to improve the sharpness of the image is inserted in a second branch B2. This contour improvement circuit 13 operates on the signals of all the elements of the sensor 3 without taking account of their sensitivity to the various color components. It therefore operates in particular on the upper part of the spatial frequency spectrum of the image. A gain circuit 14 which makes it possible to apportion the contribution of this circuit to the final image is associated with the output of this circuit.

A combination device 16 combines the various signals issuing from the branches B1 and B2. This combination is a simple addition between on the one hand the signals issuing from the contour improvement circuit 13 and the gain circuit 14 and on the other hand the signals relating to each of the color components issuing from the branch B1. Three adders 21, 22 and 23 are provided for effecting this addition.

Instead of having image information presented in the form of the components thereof in said primary colors red, green and blue, it is wished to have the information in the form known as Y, U, V. These various components Y, U and V represent respectively the luminance, information on the red and information on the blue. This form Y, U and V is particularly used for television signals. This operation is performed by means of a conversion device 25. If it is preferred to deal with only the signals R, G, B, this conversion device 25 can be considered to be a filtering matrix which is unitary and therefore performs no conversion. The information thus processed is finally stored in a memory 30, from where the images thus taken can be taken.

Preferably, the contour improvement circuit 13 operates on the upper frequencies of the spatial spectrum. For this purpose a high-pass filter 33 can be inserted in the branch B2.

The circuit 13 for improving the contours can have an x/sin(x) filtering function. Another filtering function given by the following matrix can also give useful results:

| | | |
|---|---|---|
| −0.12 | −0.21 | −0.12 |
| −0.21 | 2.32 | −0.21 |
| −0.12 | 0.21 | −0.12 |

This matrix applies, as already stated, to all the pixels of the sensor 3. For more details concerning the establishment of this matrix, the U.S. Pat. No. 6,055,340 can be consulted. This calculation by matrix can be combined with the filter 33. The various parts of the spectrum involved in the invention can be obtained by means of FIG. 3.

Thus the purpose of the device 10 is to filter the image according to a template shown by the reference G1 in FIG. 3. This FIG. 3 shows the outline, in a quadrant in space, of the various spectra in said directions H and V. This is a low-pass filter which allows the spectral components below Fs/4 to pass.

1/Fs represents the distance between pixels (FIG. 2), that is to say between the sensitive elements of the sensor. The template G2 represents the filtering on the pixels G which are favored by the distribution made on the matrix shown in FIG. 2. The improvement circuit 13 can operate on the image in the part of the spectrum defined by the template bearing the reference G3 in FIG. 3.

1. A camera having a contour improvement circuit, an apparatus formed from a sensor composed of elements sensitive to various color components of the view exhibiting an entire spectrum of spatial frequencies, at least a first image filtering device for the low frequencies of the spectrum with a view to processing the signals issuing from said sensitive elements, characterized in that it has a first branch in which said first filtering device is inserted, at least a second branch in which at least a contour improvement circuit is inserted in order to act on the high frequencies taking account of all the signals issuing from said elements, and a combination device for supplying an image from the output signals of said branches.

2. A camera as claimed in claim 1, characterized in that the contour improvement circuit is preceded by a high-pass filter for selecting the upper part of the spatial spectrum.

3. A camera as claimed in claim 1 or 2, characterized in that the contour improvement circuit operates by performing an operation of the type x/sin(x).

4. A camera as claimed in claim 1 or 2, characterized in that the contour improvement circuit operates by performing a matrix calculation on all the sensitive elements of the sensor.

5. A camera as claimed in one of claims 1 to 4, characterized in that a gain circuit is provided in order to vary the contribution of the contour improvement circuit to the image.

6. A photographic method applied in a camera as claimed in one of claims 1 to 5, characterized in that it includes the following steps:
impression of the sensor composed of elements sensitive to the various color components of the view,
processing the information from this sensor by a first processing branch operating on the elements sensitive to color,
processing the information from this sensor by a second processing branch operating on all the elements without taking account of the color and operating on the upper part of the spatial spectrum, with a view to improving the contours,
combination of the various items of information produced by said branches in order to supply an image for use.

7. A method as claimed in claim 6, characterized in that an x/sinx filtering is performed in the second branch with a view to improving the contours, after possibly selecting the upper part of the spatial spectrum.
